(19) United States
(12) Patent Application Publication
(10) Pub. No.: US 2013/0080234 A1
(43) Pub. Date: Mar. 28, 2013

(54) METHOD OF TARGETING CONSUMERS FOR UP-SELLING BASED ON PURCHASING HISTORY

(71) Applicant: Robert T. Little, Edina, MN (US)

(72) Inventor: Robert T. Little, Edina, MN (US)

(73) Assignee: NATIONAL BANKCARD SERVICES, INC., Plymouth, MN (US)

(21) Appl. No.: 13/245,149

(22) Filed: Sep. 26, 2011

(51) Int. Cl. G06Q 30/00

(52) U.S. Cl. 705/14.25

(57) ABSTRACT

One aspect is a method of offering discounted goods or services including processing a requested financial transaction from a user at a point-of-sale location via a transaction processor system. Data from the requested financial transaction is compared to an existing database reflective of data from previously requested financial transactions of the user. A discount offer based upon data from previously requested financial transactions of the user is generated. The discount offer is communicated to the user at the point-of-sale location in conjunction with the completion of the requested financial transaction.

### BACKGROUND

One aspect relates generally to the field of financial transactions, and in particular to credit services between merchants and credit service providers. More specifically, one aspect relates to the targeting consumers for up-selling based on information collecting into a unique database created from the customer's past credit card purchasing. Although many loyalty or rewards programs have been used, they do not always effectively match customers with products. For these and other reasons, there is a need for the present invention.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a block diagram of a system for processing financial transactions in accordance with one embodiment.

FIG. 2 is a flow chart illustrating the processing of a financial transaction in accordance with one embodiment.

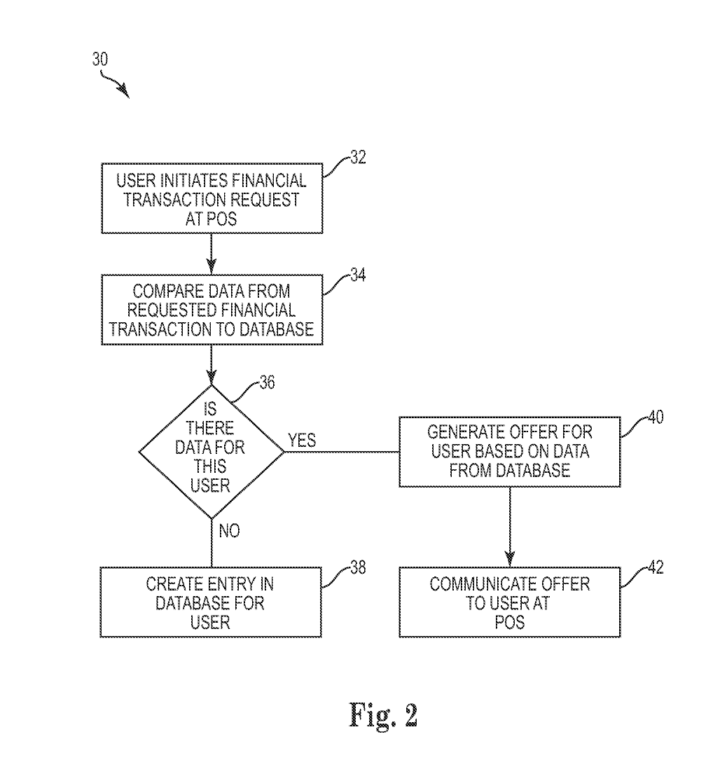

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

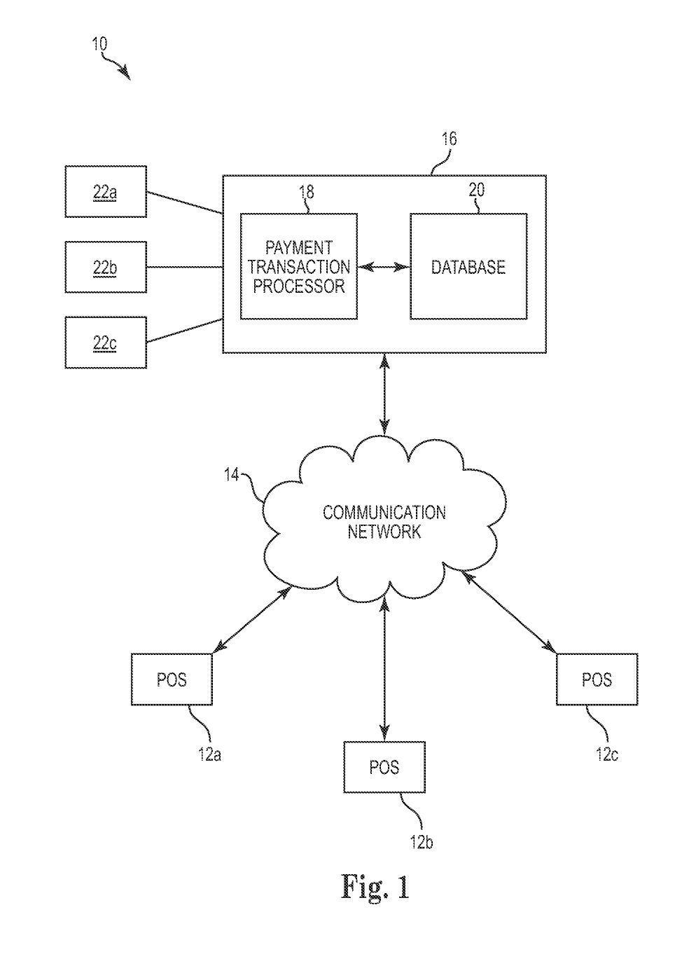

FIG. 1 illustrates transaction authorization system 10 in accordance with one embodiment. System 10 can be used to process financial transactions. In one embodiment, system 10 includes a plurality of point-of-sale (POS) devices 12a/12b/12c, communications network 14 and money transfer network 16. Money transfer network 16 includes payment transaction processor 18 and database 20. In one embodiment, money transfer network 16 is coupled to instrument authorities 22a/22b/22c, which can determine whether a particular financial transaction will be authorized.

In operation of system 10, a user initiates a financial transaction by making a purchase request at POS device 12. The purchase request typically includes sending purchase request data, such as method of payment (MOP), financial instrument being used to make the purchase (for example, a credit card), bank identification code associated with the financial instrument, item(s) being purchased, location of the purchase, retailer associated with the purchase, and the amount of the purchase. This purchase request data is transmitted to communications network 14 and routed to money transfer network 16. Depending on the type of financial instrument the user processed at POS device 12, payment transaction processor 18 can switch in an appropriate instrument authority 22, which can then analyze the purchase request data in order to determine whether the financial transaction will be authorized.

In one embodiment, payment transaction processor 18 is also coupled to database 20, which contains stored data reflective of previous financial transactions, as will be discussed more fully below. As such, the purchase request data can also be compared to the stored data in database 20. In one embodiment, the comparison is used to determine if the financial instrument being used in the current requested financial transaction has been used for previous financial transactions. If it has, stored data related to previous financial transactions with this particular financial instrument can be analyzed and a unique purchase offer can be generated and sent to the user at POS device 12 along with the authorization of the current transaction.

For example, in one embodiment, POS device 12 can be a gasoline pump at a gas station where a user is purchasing gas. In one case, the financial instrument can be a credit card that the user swipes to initiate the financial transaction. The credit card information and associated purchase request information for the current requested financial transaction are sent via communication network 14 to money transfer network 16. There, payment transaction processor 18 can compare the credit card information and associated purchase request information from the current requested financial transaction, or “the current transaction data,” against credit card information and associated purchase request information from the previous financial transactions, or “the previous transaction data,” which is stored in database 20.

If credit card information, such as a credit card account number, for the current transaction data can be matched to credit card information from previous transaction data, payment transaction processor 18 can then access those transactions and determine what previous purchases have been made using this particular credit card account. As such, payment transaction processor 18 can generate an offer that is tailored to the user associated with this credit card account. For example, if the previous transaction data indicates that this account has been used to purchase a particular snack food, a coupon for a discounted amount off, or even a free offer, of that particular snack food can be generated and then immediately communicated to the user at POS device 12 in conjunction with the completion of the current requested financial transaction.

Even though the generated offer is tailored to the user based on previous purchases, this fact would not necessarily even be known to the user. In other words, the searching of previous purchases of the user in order to generate the offer could be invisible to the user. Also, with system 10, the offer can be generated as a real time communication to the user as they are still completing the current financial transaction at POS12.

Such targeted offers can have many advantages. For example, in an embodiment where POS device 12 is at a gasoline pump at a gas station, many users will pay at the pump and then leave without ever entering the retail store associated with the gas station. The owner of the station has interest in driving those users into the retail store. Offering free or discounted goods, especially goods that the particular user has shown propensity to purchase, can be a good incentive to get users to go inside the store and potentially purchase other goods. This ability to drive user traffic is applicable to many consumer applications.

If the user is offered a discount on a random product, that particular user may have no interest in that particular random product, and thus, may have no incentive to go inside and will just drive away. Where the offer is instead based on products the user previously purchased, the user may be incentivized to go inside the store and make additional purchases.

Accordingly, transaction authorization system 10 has applicability across many different types of financial transactions. POS devices 12 can be any of a variety of devices associated with a financial transaction system, including financial transaction kiosk, an automated teller machine, a computer, and/or cash registers. They can be located independently or in or near retail or service-oriented businesses. Such POS devices 12 can be configured to be operable with any of a variety of financial instruments, including credit cards, debit cards, private label cards, stored-value instruments and others.

Once a purchase request is initiated at POS device 12, the financial instrument information and associated purchase request information are sent via communication network 14. In one embodiment, communication network 14 may include, for example, at least one of a land-line public switched telephone network, a mobile communications network such as according to the GMS or UTMS standard or any other conventionally known mobile communications standard, the Internet, a proprietary communications network, a wide area network, etc.

Money transfer network 16 receives the financial instrument information and associated purchase request information from the communication network 14. Money transfer network 16 can be a variety of networks in accordance with various embodiments. One example of money transfer network 16 is that such as provided by National Bankcard Services, Inc. of Plymouth, Minn. Included in its network, is a plurality of secure payment transaction processors 18 and associated secure databases 20.

Money transfer network 16 is coupled to instrument authorities 22a/22b/22c, which determine whether a particular financial transaction will be authorized. Instrument authorities 22a/22b/22c can be a variety of authorities associated with a variety of financial instruments in accordance with various embodiments. For example, instrument authorities 22a/22b/22c can be credit card institutions, such as VISA, Master Card, American Express, Discover, etc., banking institutions or other financial authorities.

Any of an appropriate one of instrument authorities 22a/22b/22c receive the purchase request data from money transfer network 16 to determine whether the transaction should be authorized denied. For example, if a user associated with a financial transaction used a VISA card to do so, money transfer network 16 would interface with VISA as a selected instrument authority 22a, for example, in order to complete the financial transaction. The authorization or rejection is then directed back to money transfer network 16 for completion of the financial transaction.

In one embodiment, the authorization of certain financial instruments can be handled internally within money transfer network 16 and without the intervention of instrument authorities 22a/22b/22c. For example, some private label cards, gift cards, point cards and other stored-value instruments can be processed, authorized and/or denied with payment transaction processors 18 of money transfer network 16.

In one embodiment, users of transaction authorization system 10 will use a MOP or financial instrument that is regulated by a PCI Data Security Standard (PCIDSS). PCIDSS are well-known in the art and are comprehensive standards and supporting materials to enhance payment card data security. These include a framework for developing a robust payment card data security process—including prevention, detection and appropriate reaction to security incidents. For example, transactions that include credit card information must carefully follow these standards.

As such, in one embodiment, database 20 includes stored data reflective of previous financial transactions, but does not actually store the financial instrument identification, such as the credit card number, directly. For example, no actual credit card number is stored in database 20 such that security is preserved. Instead, payment transaction processor 18 within money transfer network 16 encrypts and/or hashes financial instrument identification, such as the credit card number, associated with both previous and current financial transactions in order to create a unique secured identifier that can be stored (in the case of previous financial transactions) and compared (in the case of current financial transactions). Actual financial instrument identification, such as the credit card number, can be encrypted and/or hashed in accordance with various know encryption and hashing techniques to create the unique secured identifier.

That unique secured identifier for that financial instrument is then stored in database 20, in conjunction with the other data from the financial transaction, such as purchased item and amount. Since each unique secured identifier is maintained, any additional financial transactions that occur with that financial instrument can be stored in database 20 and associated with that any other previous financial transaction data associated with that particular financial instrument. Where there are numerous financial transactions for a particular financial instrument, database 20 will contain useful information against which current financial transactions can be compared. Using this stored data, in one embodiment stored by unique secured identifier, offers can be generated that will be useful in potentially directing further purchases.

In one embodiment, the encryption and/or hashing done on the financial instrument identification to obtain the unique secured identifier allows the data related to previous financial transactions to be stored without any identification of the actual financial instrument identification, such as a credit card number. As such, if a third party obtained or “hacked” data from database 20, the actual financial instrument identification, such as a credit card number cannot be gleaned from the unique secured identifier by the third party.

FIG. 3 is a flow chart illustrating a financial transaction method in accordance with one embodiment. Such a method could be used in association with transaction authorization system 10, for example. In one embodiment, a user of a financial instrument initiates a financial transaction at a point-of-sale (POS) device at 32. The POS devices could be located at any of a variety of business, including for example, gas stations, department stores, movie theaters or any of a variety of other retail shops.

Once the financial transaction is initiated, data associated with that current financial transaction is transmitted so that it can be compared against data from previous financial transactions that is stored in a database at 34. A determination is then made at 36 at to whether there is any data stored for this particular financial instrument from the current financial transaction from previous financial transactions. If there is no such data, then a new data entry is created for that particular financial instrument at 38. As such, any subsequent transactions involving that particular financial instrument can also be associated and stored.

If there is already data stored for that particular financial instrument, an offer can be generated based on the stored data at 40. For example, if the data associated with the current financial transaction indicates that the user is purchasing gas at a retailer that also offers snack items and that this user has previously purchased a particular type of snack item, such as potato chips, the generated offer can be a discounted amount off that particular type of snack item, potato chips. The generated offer may also include a condition that it be used in conjunction with the current financial transaction, and may expire thereafter.

In another example the data associated with the current financial transaction could indicate that the user is movie theater tickets at a movie theater complex that also offers snack items and that this user has previously purchased a particular type of snack item, such as popcorn. In that case, the generated offer can be a discounted amount off that particular type of snack item, popcorn. Again, in one example, the generated offer may also include a condition that it be used in conjunction with the current financial transaction, and may expire thereafter. Various other examples of such “up-selling”, or offering discounts that are based on actual past sales for the particular consumer, are evident to one skilled in the art.

Once the offer is generated, it is communicated to the user at the same POS device where the user initiated the current financial transaction at 42. In one embodiment, the offer must be acted upon by the user within a limited amount of time. In one example, it would need to be accepted within the current financial transaction.

In one embodiment, in addition to generating and communicating the offer, data in the database associated with the particular financial instrument is updated with the data from the current financial transaction. As such, purchase stored data associated with the particular financial instrument continues to grow and future offers generated can reflect a continually growing body of purchase information associated with the particular financial instrument.

In one embodiment, an offer can also be generated after 38 even where no data is stored for the particular financial instrument in the current financial transaction. In such a case, the offer would be more random and obviously not based on data from previous financial transactions.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof

What is claimed is:

1. A method of offering discounted goods or services comprising:
processing financial transactions from a user at a point-of-sale location via a transaction processor system;
generating a proprietary database from data processed in the financial transactions, the data comprising a financial instrument identification and item purchase information;
generating a discount offer from the proprietary database, the discounted offer based at least on the item purchase information and payment; and
communicating the discount offer to the user at the point-of-sale location.

2. The method of claim 1, wherein processing financial transactions from a user at a point-of-sale location comprises processing credit card information from the user.

3. The method of claim 1, wherein processing financial transactions from a user comprises determining whether a financial transaction is authorized.

4. The method of claim 3, wherein determining whether a financial transaction is authorized comprises interaction with an instrument authority.

5. The method of claim 1, wherein the data processed in the financial transactions comprises at least one of a group comprising: MOP, number of items purchased, a credit card number, a bank identification code of the instrument issuer the item(s) being purchased, the location of the purchase, the retailer associated with the purchase, and the amount of the purchase.

6. The method of claim 1, wherein communicating the discount offer comprises communicating the offer to the user in real time at the point-of-sale location while the user is still completing a financial transaction initiated at the point-of-sale location.

7. The method of claim 6, wherein communicating the discount offer comprises conditioning the offer of accepting the offer in conjunction with the completion of the financial transaction.

8. The method of claim 1, wherein generating a proprietary database comprises encrypting and/or hashing financial instrument identification to generate a unique secured identifier, and storing data by the unique secured identifier.

9. A method of offering discounted goods or services comprising:
processing a current requested financial transaction from a user using a financial instrument at a point-of-sale location via a transaction processor system;
comparing data from the current requested financial transaction to stored data from previously requested financial transactions associated with the financial instrument;
generating a discount offer that is based upon data from previously requested financial transactions of the financial instrument; and
communicating the discount offer to the user at the point-of-sale location in conjunction with the completion of the current requested financial transaction.

10. The method of claim 9, wherein processing the current requested financial transaction from a user at a point-of-sale location comprises processing credit card information from the user.

11. The method of claim 9, wherein processing the current requested financial transaction from a user comprises determining whether a financial transaction is authorized.

12. The method of claim 11, wherein determining whether a financial transaction is authorized comprises interaction with an instrument authority.

13. The method of claim 9, wherein the data processed in the current requested financial transaction comprises at least one of a group comprising:
MOP, number of items purchased, a credit card number, a bank identification code of the instrument issuer the item(s) being purchased, the location of the purchase, the retailer associated with the purchase, and the amount of the purchase.

14. The method of claim 9, wherein communicating the discount offer comprises communicating the offer to the user in real time at the point-of-sale location while the user is still completing the current requested financial transaction initiated at the point-of-sale location.

15. The method of claim 14, wherein communicating the discount offer comprises conditioning the offer of accepting the offer in conjunction with the completion of the current requested financial transaction.

16. The method of claim 1, further comprising generating a proprietary database by encrypting and/or hashing financial instrument identification to generate a unique secured identifier, such that the stored data from previously requested financial transactions is associated with a unique secured identifier.

17. A transaction processor system comprising:
a point-of-sale device configured for processing a current requested financial transaction from a user using a financial instrument;
a processor coupled to the point-of-sale device over a network and configured to:
compare data from the current requested financial transaction stored data from previously requested financial transactions associated with the financial instrument;
generate a discount offer that is based upon data from previously requested financial transactions of the financial instrument; and
communicate the discount offer to the user at the point-of-sale location in conjunction with the completion of the current requested financial transaction.

18. The system of claim 17, wherein the data compared in the current requested financial transaction comprises at least one of a group comprising:
MOP, number of items purchased, a credit card number, a bank identification code of the instrument issuer the item(s) being purchased, the location of the purchase, the retailer associated with the purchase, and the amount of the purchase.

19. The system of claim 17, wherein communicating the discount offer comprises communicating the offer to the user in real time at the point-of-sale location while the user is still completing the current requested financial transaction initiated at the point-of-sale location.
